(19) United States
(12) Patent Application Publication
(10) Pub. No.: US 2005/0251616 A1
(43) Pub. Date: Nov. 10, 2005

(54) FACILITY MONITORING SYSTEM, METHOD, AND ARTICLE OF MANUFACTURE FOR OBTAINING DATA FROM NON-VOLATILE MEMORY AND VOLATILE MEMORY

(75) Inventors: Robert Spriggs, Gardnerville, NV (US); Kenneth Paul Ceglia, Gardnerville, NV (US); Michael D. Peden, Gardnerville, NV (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/709,433

(22) Filed: May 5, 2004

(51) Int. Cl. G06F 12/00

(52) U.S. Cl. 711/101; 711/104

(57) ABSTRACT

A facility monitoring system, an article of manufacture, and a method for obtaining data stored in a non-volatile memory and data stored in volatile memory are provided. The method includes retrieving a first data set stored in the non-volatile memory associated with a first computer wherein the first data set includes data collected from at least one sensor over a first predetermined time interval. The method further includes retrieving a second data set stored in the volatile memory associated with a second computer wherein the second data set comprises data collected from the at least one sensor over a second time interval after the first time interval. Finally, the method includes storing at least a portion of the first data set and the second data set in a first memory.

### BACKGROUND OF INVENTION

Facility monitoring systems have been implemented that monitor the activity or operational status of devices in a manufacturing facility. Generally, the facility monitoring system includes a data acquisition computer server that monitors signals from hundreds or thousands of sensors measuring operating parameters associated with devices in the facility. The data acquisition server sequentially writes the data obtained from each sensor from a volatile memory to a historical non-volatile memory that can be viewed by a user. However, because the data acquisition server sequentially writes hundreds or thousands of values from the volatile memory to the historical non-volatile memory, the non-volatile memory may not contain an updated measurement value associated with a specific sensor for several minutes. Thus, a user viewing data in the historical non-volatile memory may not be able to obtain and view the latest values received by the data acquisition server for a specific sensor for several minutes.

Thus, there is a need for a facility monitoring system that would allow a user to obtain and/or concurrently view both the data in a historical non-volatile memory and the latest data stored in a volatile memory for a specific sensor or multiple sensors.

### SUMMARY OF INVENTION

A method for obtaining data stored in a non-volatile memory and data stored in volatile memory in a facility monitoring system in accordance with an exemplary embodiment is provided. The method includes retrieving a first data set stored in the non-volatile memory associated with a first computer wherein the first data set includes data collected from at least one sensor over a first predetermined time interval. The method further includes retrieving a second data set stored in a volatile memory associated with the second computer wherein the second data set comprises data collected from the at least one sensor over a second time interval after the first time interval. Finally, the method includes storing at least a portion of the first data set and the second data set in a first memory.

A method for obtaining and displaying data stored in a non-volatile memory and data stored in volatile memory in a facility monitoring system in accordance with an exemplary embodiment is provided. The method includes retrieving a first data set stored in the non-volatile memory associated with a first computer wherein the first data set includes data collected from at least one sensor over a first predetermined time interval. The method further includes retrieving a second data set stored in a volatile memory associated with the second computer wherein the second data set comprises data collected from the at least one sensor over a second time interval after the first time interval. Finally, the method includes concurrently displaying at least a portion of the first data set and the second data set on a computer monitor.

A facility monitoring system for obtaining data stored in a non-volatile memory and data stored in a volatile memory in accordance with another exemplary embodiment is provided. The system includes a first computer operatively associated with the non-volatile memory storing a first data set. The first data set has data collected from at least one sensor over a first time interval. The system further includes a second computer having the volatile memory storing a second data set having data collected from the at least one sensor over a second time interval after the first time interval. Finally, the system includes a third computer configured to receive the first and second data sets from at least one of the first and second computers and to store at least a portion of the first and second data sets in a first memory.

A facility monitoring system for obtaining and displaying data stored in a non-volatile memory and data stored in a volatile memory in accordance with another exemplary embodiment is provided. The system includes a first computer operatively associated with the non-volatile memory storing a first data set. The first data set has data collected from at least one sensor over a first time interval. The system further includes a second computer having the volatile memory storing a second data set having data collected from the at least one sensor over a second time interval after the first time interval. Finally, the system includes a third computer configured to receive the first and second data sets from at least one of the first and second computers and to display at least a portion of the first and second data sets on a computer monitor.

A facility monitoring system for obtaining data stored in a non-volatile memory and data stored in a volatile memory in accordance with another exemplary embodiment is provided. The system includes a first computer means operatively associated with the non-volatile memory for storing a first data set. The first data set having data collected from at least one sensor over a first time interval. The system further includes a second computer means having the volatile memory for storing a second data set having data collected from the at least one sensor over a second time interval after the first time interval. Finally, the system includes a third computer means for receiving the first and second data sets from at least one of the first and second computers and storing at least a portion of the first and second data sets in a first memory.

An article of manufacture in accordance with another exemplary embodiment is provided. The article of manufacture includes a computer storage medium having a computer program encoded therein for obtaining data stored in a non-volatile memory and data stored in volatile memory in a facility monitoring system. The computer storage medium includes code for retrieving a first data set stored in the non-volatile memory associated with a first computer wherein the first data set includes data collected from at least one sensor over a first predetermined time interval. The computer storage medium further includes code for retrieving a second data set stored in the volatile memory associated with a second computer wherein the second data set comprises data collected from the at least one sensor over a second time interval after the first time interval. Finally, the computer storage medium includes code for storing at least a portion of the first data set and the second data set in a first memory.

A facility monitoring system in accordance with another exemplary embodiment is provided. The facility monitoring system includes a computer including a non-volatile memory and a volatile memory. The computer is configured to store a first data set in the non-volatile memory. The first data set has data collected from at least one sensor over a first time interval. The computer is further configured to store in the volatile memory a second data set having data collected from the at least one sensor over a second time interval after the first time interval. The computer is further configured to retrieve the first data set from the non-volatile memory and the second data set from the volatile memory and to store the first and second data sets in either the volatile memory or a first memory.

Other systems and/or methods according to the embodiments will become or are apparent to one with skill in the art upon review of the following drawings and detailed description. It is intended that all such additional systems and methods be within the scope of the present invention, and be protected by the accompanying claims.

### BRIEF DESCRIPTION OF DRAWINGS

FIG. 1 illustrates a facility monitoring system having a client computer, a database computer server, and a data acquisition computer server in accordance with an exemplary embodiment;

FIG. 2 depicts a data set stored in a non-volatile memory of the database computer server;

FIG. 3 depicts a data set stored in a volatile memory of the data acquisition computer server;

FIG. 4 depicts a first data request message sent from the client computer to the database computer server;

FIG. 5 depicts a second data request message sent from the database computer server to the data acquisition computer server;

FIG. 6 depicts a first data return message sent from the data acquisition computer server to the database computer server;

FIG. 7 depicts a second data return message sent from the database computer server to the client computer;

FIGS. 8-10 are flowcharts of a method for obtaining and displaying data stored in a non-volatile memory and data stored in volatile memory in the facility monitoring system of FIG. 1 in accordance with another exemplary embodiment;

FIG. 11 is a graphical plot of a portion of a first data set and a second data set associated with one sensor.

### DETAILED DESCRIPTION

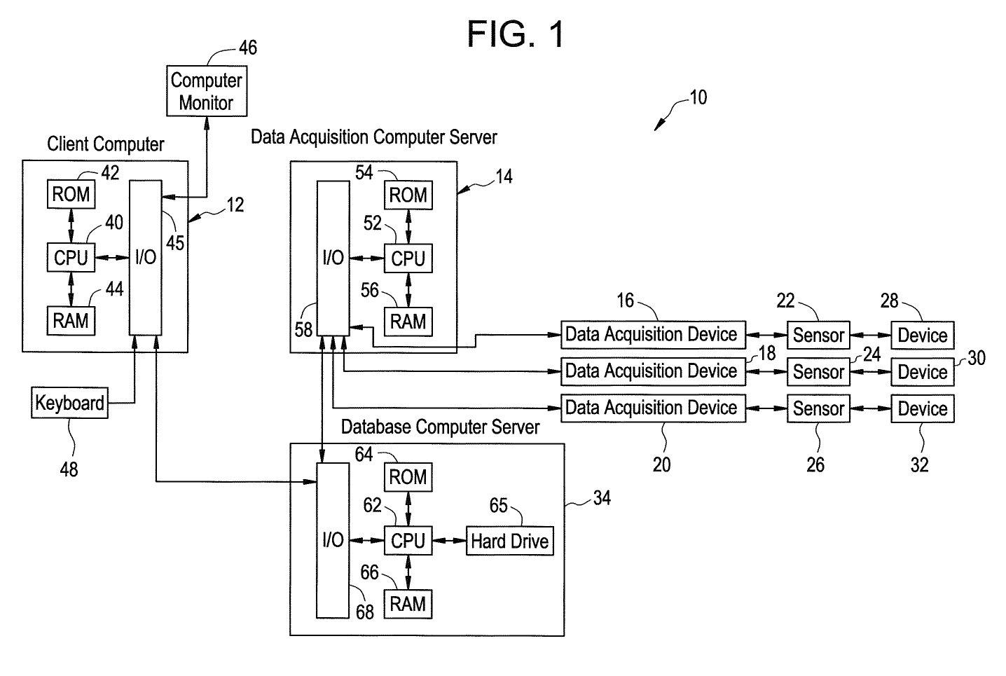

Referring to FIG. 1, a facility monitoring system 10 is illustrated that can display data sets associated with sensors in a plant or processing facility. In particular, the system 10 includes a data acquisition computer server 14 which can obtain sampled data values from a plurality of sensors. The data acquisition computer server 14 stores the most recently obtained data values in one or more data sets in a volatile memory. Thereafter, the data acquisition computer server 14 periodically sends the data sets to the database computer server 34 that stores the data sets in a non-volatile memory. The system 10 further includes computer 12 operably communicating with the database computer server 34 and the data acquisition computer server 14. Still further, the system 10 includes data acquisition devices 16, 18, 20, sensors 22, 24, 26, and devices 28, 30, 32 explained in greater detail below.

When a user of the client computer 12 requests to retrieve data sets associated with predetermined sensors over a predetermined time interval, the client computer 12 sends a first data request message to the data base computer server 34. The database computer server 34 retrieves a first data set stored in non-volatile memory therein. The first data set includes sampled data values obtained from one or more sensors over a first time interval. Further, if a portion of the requested information is stored in the volatile memory of the data acquisition computer server 14, the server 34 sends a second data request message to the server 14. In response to the second data request message, the data acquisition computer server 14 sends a first data return message to the database computer server 34 containing a second data set with at least a portion of the requested information. The second data set includes sampled data values obtained from the one or more sensors over a second time interval after the first time interval. Thereafter, the database computer server 34 sends a second data return message to the client computer 12 containing the first and second data sets.

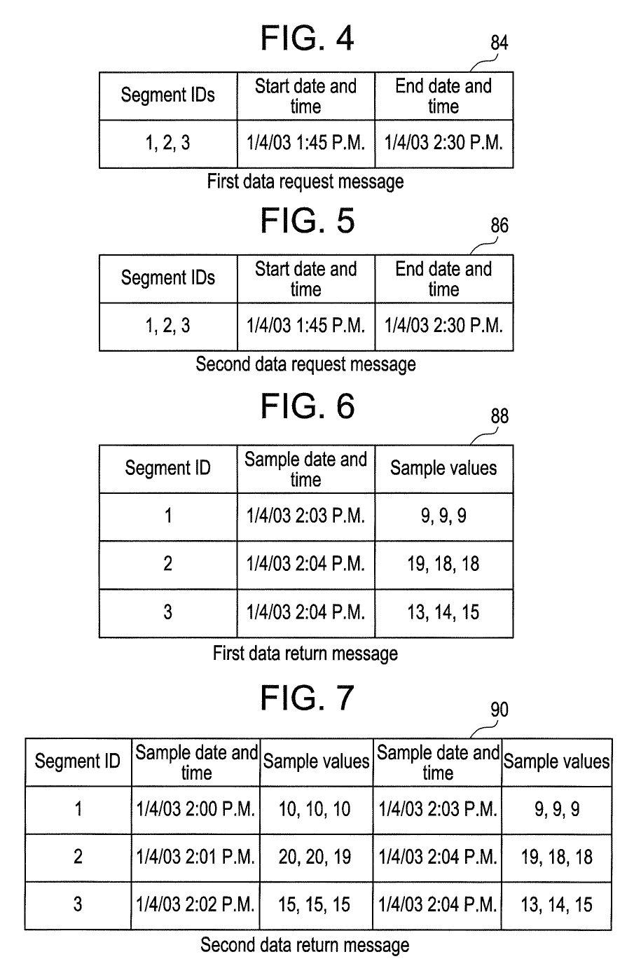

Referring to FIGS. 1 and 4, the client computer 12 is provided to request data sample values (e.g. measured values) associated with manufacturing equipment and then upon receipt of the sample values to display them on a computer monitor 46. In particular, the client computer 12 can generate a first data request message 84 to obtain information relating to devices 28, 30, and 32. As shown, the first data request message 84 includes the following attributes: (i) a list of Segment IDs, (ii) start date and time, (iii) end date and time. Each Segment ID is a unique number that identifies a predetermined sensor. For example, the sensor 22 has a Segment ID having a value of “1”, the sensor 24 has a Segment ID having a value of “2”, and the sensor 26 has a Segment ID having a value of “3”. The “start date and time” attributes and the “end date and time” attributes define a time interval used for selecting data sample values associated with the identified sensors. For example, the first data request message 84 is requesting data samples associated with sensors 22, 24, 26 (identified by Segment IDs 1, 2, 3, respectively) that were obtained during a time interval from Jan. 4, 2003 at 1:45 P.M. to Jan. 4, 2003 at 2:30 P.M. As will be explained in greater detail below, each plurality of data sample values associated with a listed Segment ID having an associated “sample date and time” that falls within the time interval specified by the first data request message will be returned to the client computer 12.

The client computer is further configured to both (i) generate data reports based upon received data sample values (e.g. measured values) associated with manufacturing equipment, and (ii) to export the received data sample values to other software applications.

As shown, the client computer 12 includes a central processing unit (CPU) 40, a read-only memory (ROM) 42, a volatile memory such as a random access memory (RAM) 44 and an input/output (I/O) interface 45. The CPU 40 operably communicates with the ROM 42, the RAM 44, and the I/O interface 45. The computer readable media including ROM 42 and RAM 44 may be implemented using any of a number of known memory devices such as PROMs, EPROMs, EEPROMS, flash memory or any other electric, magnetic, optical or combination memory device capable of storing data, some of which represent executable instructions used by the CPU 40. The CPU 40 communicates via the I/O interface 45 with a keyboard 48, the computer monitor 46, the database computer server 34, and the data acquisition computer server 14.

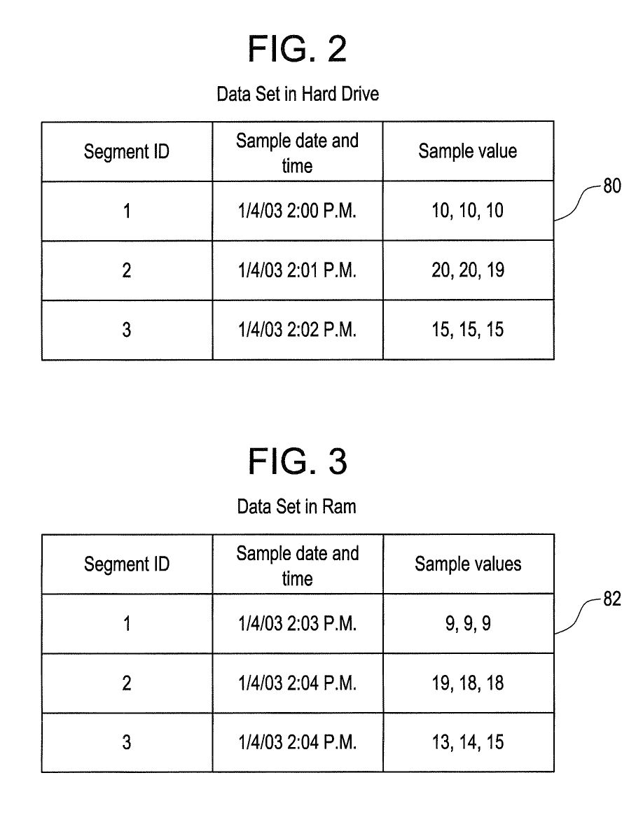

Referring to FIGS. 1, 2 and 5, the database computer server 34 is provided to periodically receive data sample values associated with predetermined Segment IDs from the data acquisition computer server 14. Thereafter, the database computer server 34 stores the data sample values in non-volatile memory, such as the hard drive 65. For example, the database computer server 34 can store a data set 80 in the hard drive 65 that was received from data acquisition computer server 14 including data associated with sensors 22, 24, 26. As shown, the data set 80 includes three records each having the following attributes: (i) a Segment ID, (ii) sample date and time, (iii) sample values. The “sample values” attribute corresponds to the actual data sample values obtained from the data acquisition device receiving a signal from a predetermined sensor. For example, the Segment ID having a value of “1” can have data sample values 10, 10, 10 associated therewith. The “sample date and time” attribute corresponds to the date and the time in which a first data sample value of a plurality of data sample values was obtained by a data acquisition device coupled to a sensor. In other words, the “sample date and time” attribute corresponds to a time when the data collection of a plurality of data sample values was commenced by the data acquisition device. For example, the data set 80 in the hard drive 65 has a first record wherein the first data sample value was obtained on Jan. 4, 2003 at 2 P.M. It should be noted that although only three data sample values are shown for each Segment ID in data set 80, each Segment ID could have a plurality of additional data sample values associated therewith. For example, each Segment ID could have at least 1024 data samples associated therewith.

The database computer server 34 is further provided to receive a first data request message from the client computer 12 requesting predetermined data sample values and then to return the requested data sample values to the client computer 12. In particular, when the database computer server 34 receives a data request message from computer 12 that requests (i) some data samples stored in server 34, and (ii) some data sample values that are not stored in the server 34 (e.g., data samples obtained within the last 15 minutes), server 34 sends a second data request message to the data acquisition computer server 14 requesting the more recently obtained data sample values. For example, when database computer server 34 receives the first data request message 84 from the client computer 12, the database computer server 34 can generate a second data request message 86. As shown, the second data request message 86 has substantially the same attributes the first data request message 84. After generating the message 86, the database computer server 34 sends the message 86 to the data acquisition computer server 14 via I/O interface 68.

As shown, the database computer server 34 includes a CPU 62, a ROM 64, a non-volatile memory such as hard drive 65, a volatile memory such as RAM 66, and an I/O interface 68. The CPU 62 operably communicates with the ROM 64, the hard drive 65, the RAM 66, and the I/O interface 68. The computer readable media including ROM 64, RAM 66, and hard drive 65 may be implemented using any of a number of known memory devices such as PROMs, EPROMs, EEPROMS, flash memory or any other electric, magnetic, optical or combination memory device capable of storing data, some of which represent executable instructions used by CPU 62. The CPU 62 communicates via the I/O interface 68 with the client computer 12 and the data acquisition computer server 14.

Referring to FIGS. 1, 3 and 6, the data acquisition computer server 14 is provided to obtain data sample values associated with a plurality of sensors. In particular, the data acquisition computer server 14 receives data sample values from the data acquisition device 16 corresponding to signal values generated by a sensor 22. The sensor 22 generates a signal indicative of an operating parameter of device 28. Further, the data acquisition computer server 14 receives data sample values from the data acquisition device 18 corresponding to signal values generated by a sensor 24. The sensor 24 generates a signal indicative of an operating parameter of device 30. Still further, the data acquisition computer server 14 receives data sample values from the data acquisition device 20 corresponding to signal values generated by a sensor 26. The sensor 26 generates a signal indicative of an operating parameter device 32.

When the data acquisition computer server 14 receives a plurality of data sample values from a sensor, server 14 stores the plurality of data sample values in a record in RAM 56. In particular, the computer server 14 can store a record in RAM 56 having the following attributes: (i) a Segment ID, (ii) a sample date and time, (iii) sample values. For example, the data acquisition computer server 14 can receive a plurality of data sample values from sensor 22 and thereafter store a record in RAM 56 including: (i) a Segment ID having a value of “1” corresponding to the sensor 22, (ii) a sample date and time having values equal to Jan. 4, 2003 and 2:03 P.M. which indicate when the collection of data sample values was initiated, and (iii) a plurality of data sample values such as 9, 9, 9 obtained from a signal generated by sensor 22.

Further, the data acquisition computer server 14 can periodically receive a plurality of data sample values from the other sensors and store the corresponding data sample values in RAM 56. As shown, for example, the data acquisition computer server 14 can generate a data set 82 having three data records identified by Segment IDs 1, 2, 3 containing data sample values obtained from sensors 22, 24, 26, respectively.

Referring to FIGS. 5 and 6, when the data acquisition computer server 14 receives the second data request message from the database computer server 34, the server 14 generates a first data return message containing the requested information. For example, when server 14 receives the second data request message 86, the server 14 can access the stored data set 82 in RAM 56 and generate the first data return message having a first data set 88 based on the data set 82. Thereafter, the data acquisition computer server 14 can send the first data return message having the data set 88 to the database computer server 34.

As shown, the data acquisition computer server 14 includes a CPU 52, a ROM 54, a volatile memory such as a RAM 56 and an I/O interface 58. The CPU 52 operably communicates with the ROM 54, the RAM 56, and the I/O interface 58. The computer readable media including ROM 54 and RAM 56 may be implemented using any of a number of known memory devices such as PROMs, EPROMs, EEPROMS, flash memory or any other electric, magnetic, optical or combination memory device capable of storing data, some of which represent executable instructions used by CPU 52. The CPU 52 communicates via the I/O interface 58 with the client computer 12, the data acquisition computer server 14, and the data acquisition devices 16, 18, 20.

Referring to FIGS. 1, 2, 6, 7, the database computer server 34 is further provided to receive the first data return message from the data acquisition computer server 14 and to generate a second data return message. The second data return message will include a first data set obtained from data records stored in hard drive 65 corresponding to “older” data sample values obtained from the predetermined sensors over a first predetermined time interval. Further, the second data return message will include a second data set obtained from the data records in the first data return message from the data acquisition computer server 14. The second data set includes more recently obtained data from the predetermined sensors over a second predetermined time interval that occurs after the first predetermined time interval. For example, the database computer server 34 can receive the first data return message having a first data set 88 from the data acquisition computer server 14 and combine the first data set 88 with the second data set 80 stored in the hard drive 65, to obtain a combined data set 90. Thereafter, database computer server 34 can send the second data return message including the data set 90 to the client computer 12.

Referring to FIGS. 1 and 11, the client computer 12 can receive the second data return message from the database computer server 34 and display at least a portion of the first and second data sets on the computer monitor 46. For example, when the client computer 12 receives the second data return message containing the data set 90, the computer 12 can display the sample data values associated with Segment ID=“1” on a graphical plot 122 generated on computer monitor 46. As shown, the graphical plot 122 includes points 124, 126, 128 corresponding to data sample values 10, 10, 10, respectively, and points 130, 132, 134 corresponding to data sample values 9, 9, 9, respectively.

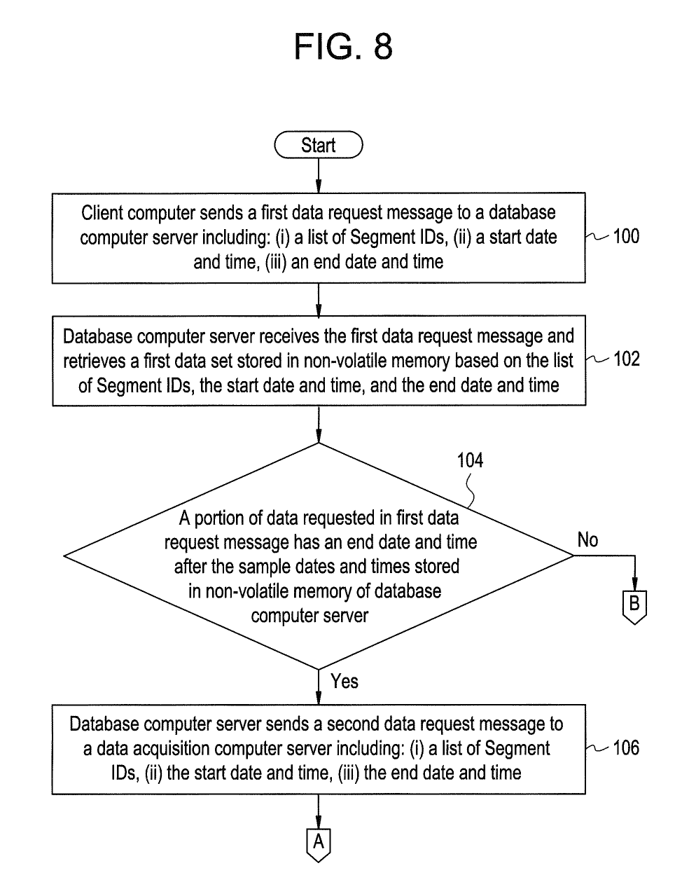

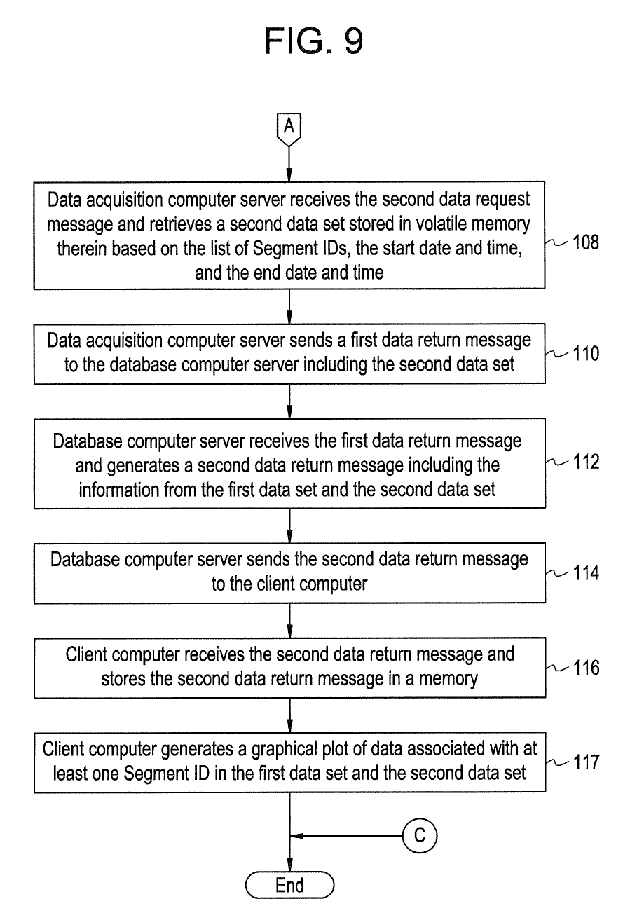

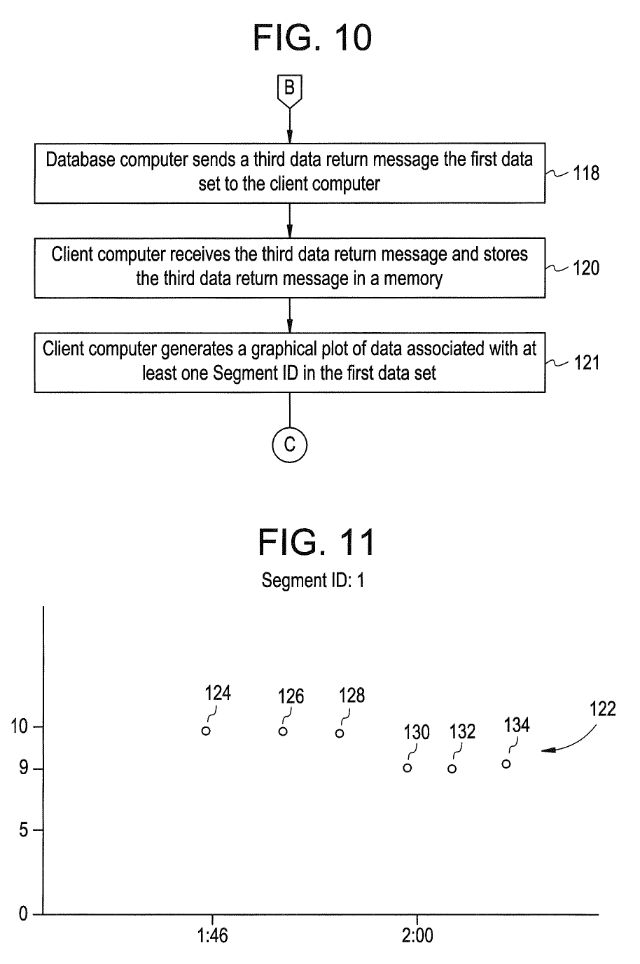

Referring to FIGS. 8, 9, and 10, a method for concurrently displaying data stored in a non-volatile memory (e.g. hard drive 65) and data stored in a volatile memory (e.g., RAM 56) in a facility monitoring system 10 will now be described.

At step 100, the client computer 12 sends a first data request message to the database computer server 34 including: (i) a list of Segment IDs, (ii) a start date and time, and (iii) end date and time. For example, the client computer 12 can send a first data request message 84 to the database computer server 34.

At step 102, the database computer server 34 receives the first data request message and retrieves a first data set stored in a non-volatile memory based on the list of Segment IDs, the start date and time, and the end date and time. For example, the server 34 can receive the first data request message 84 and retrieve the data set 80 from the hard drive 65.

At step 104, the database computer server 34 makes a determination as to whether a portion of the data requested in the first data request message has an “end date and time” after the “sample date and time” of a first data set stored in the hard drive 65 of server 34. If the value of step 104 equals “yes”, the method advances to step 106. Otherwise, the method advances to step 118.

At step 106, the database computer server 34 sends a second data request message to the data acquisition computer server 14 including: (i) the list of Segment IDs, (ii) the start date and time, (iii) the end date and time. For example, the database computer server 34 can send a second data request message 86 to the data acquisition computer server 14.

At step 108, the data acquisition computer server 14 receives the second data request message and retrieves a second data set stored in RAM 56 based on the list of Segment IDs, the start date and time, and the end date and time. For example, the server 14 can receive the second data request message and retrieve the second data set 88 from RAM 56.

At step 110, the data acquisition computer server 14 sends a first data return message including the second data set to the database computer server 34. For example, the data acquisition computer server 14 can send a first data return message having a second data set 88 to the database computer server 34.

At step 112, the database computer server 34 receives the first data return message and generates a second data return message including the information from the first data set and the second data set. For example, the database computer server 34 can receive the first data return message and generate a second data return message including the data set 90.

At step 114, the database computer server 34 sends the second data return message to the client computer 12.

At step 116, the client computer 12 receives the second data return message and stores the second data return message in a memory such as RAM 44. It should be noted that client computer 12 could alternately store the second data return message in ROM 42 or in any other type of storage media such as CD-ROMS, or computer diskettes, or flash memories for example.

At step 117, the client computer generates a graphical plot of the data associated with at least one Segment ID in the first data set and the second data set. For example, the client computer 12 can receive the second data return message having the data set 90 and generate the graphical plot 122 on computer monitor 46 corresponding to the Segment ID having a value of “1”.

Returning again to step 104, if the value of step 104 equals “no”, the method advances to step 118. At step 118 the database computer server 34 sends a third data return message containing the first data set to the client computer 12.

Next at step 120, the client computer 12 receives the third data return message and stores the third data return message in a memory such as RAM 44. It should be noted that client computer 12 could alternately store the third data return message in ROM 42 or in any other type of storage media such as CD-ROMS, or computer diskettes, or flash memories for example.

Next at step 121, the client computer 12 generates a graphical plot of the data associated with at least one Segment ID in the first data set.

After either of steps 121, 117, the method is ended.

In an alternate embodiment of the system 10, the client computer 12, the database computer server 34, and the data acquisition computer server 14 could be implemented using a single computer (not shown) having a CPU, a RAM, a ROM, a hard drive and an I/O interface, that is operably coupled to the data acquisition devices.

The facility monitoring system and method in accordance with exemplary embodiments provide a substantial advantage over other systems and methods. In particular, the system and method provided a technical effect of allowing a user to obtain and concurrently view on a computer monitor both the data in a historical non-volatile memory and the latest data stored in a volatile memory for a specific sensor. Thus, a user can obtain a complete view of the data values obtained over a desired time interval from a sensor, including the most recent data values, for determining the operating characteristics of a device.

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and/or executed by a computer, the computer becomes an apparatus for practicing the invention. When implemented on a general-purpose microprocessor, the computer program code segments configure the microprocessor to create specific logic circuits.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another.

1. A method for obtaining data stored in a non-volatile memory and data stored in volatile memory in a facility monitoring system, comprising:
retrieving a first data set stored in the non-volatile memory associated with a first computer wherein the first data set includes data collected from at least one sensor over a first predetermined time interval;
retrieving a second data set stored in the volatile memory associated with a second computer wherein the second data set comprises data collected from the at least one sensor over a second time interval after the first time interval; and,
storing at least a portion of the first data set and the second data set in a first memory.

2. The method of claim 1 wherein the first data set corresponds to values obtained from a plurality of sensor signals measuring operating parameters associated with a plurality of devices in a plant or processing facility.

3. The method of claim 1 further comprising sending a first data request message from a third computer to the first computer requesting information corresponding to the first and second data sets.

4. The method of claim 3 further comprising sending a second data request message from the first computer to the second computer requesting information corresponding to the second data set, in response to the first computer receiving the first data request message.

5. The method of claim 4 further comprising sending the first data set from the second computer to the first computer in response to the second computer receiving the second data request message.

6. The method of claim 5 further comprising sending the first data set and the second data set from the first computer to the third computer.

7. The method of claim 1 wherein the non-volatile memory comprises a hard drive and the volatile memory comprises random-access memory.

8. The method of claim 1 further comprising generating a graphical plot of at least a portion of the first data set and the second data set on a computer monitor.

9. The method of claim 1 further comprising generating a data report based on at least a portion of the first data set and the second data set.

10. The method of claim 1 further comprising exporting at least a portion of the first data set and the second data set to a first software application.

11. A method for obtaining and displaying data stored in a non-volatile memory and data stored in volatile memory in a facility monitoring system, comprising:
retrieving a first data set stored in the non-volatile memory associated with a first computer wherein the first data set includes data collected from at least one sensor over a first predetermined time interval;
retrieving a second data set stored in the volatile memory associated with a second computer wherein the second data set comprises data collected from the at least one sensor over a second time interval after the first time interval; and,
concurrently displaying at least a portion of the first data set and the second data set on a computer monitor.

12. A facility monitoring system for obtaining data stored in a non-volatile memory and data stored in a volatile memory, comprising:
a first computer operatively associated with the nonvolatile memory storing a first data set, the first data set having data collected from at least one sensor over a first time interval;
a second computer having the volatile memory storing a second data set having data collected from the at least one sensor over a second time interval after the first time interval; and,
a third computer configured to receive the first and second data sets from at least one of the first and second computers and to store at least a portion of the first and second data sets in a first memory.

13. The system of claim 12 wherein the first data set corresponds to values obtained from a plurality of sensor signals measuring operating parameters associated with a plurality of devices.

14. The system of claim 12 wherein the third computer is further configured to send a first data request message to the first computer requesting information corresponding to the first and second data sets.

15. The system of claim 14 wherein the first computer is further configured to send a second data request message to the second computer requesting information corresponding to the second data set, in response to the first data request message.

16. The system of claim 15 wherein the second computer is further configured to send the first data set to the first computer in response to the second data request message.

17. The system of claim 16 wherein the first computer is further configured to send the first data set and the second data set to the third computer.

18. The system of claim 12 wherein the non-volatile memory comprises a hard drive and the volatile memory comprises a random-access memory.

19. The system of claim 12 wherein the third computer is further configured to
generate a graphical plot of at least a portion of the first data set and the second data set on the computer monitor.

20. A facility monitoring system for obtaining and displaying data stored in a non-volatile memory and data stored in a volatile memory, comprising:
a first computer operatively associated with the nonvolatile memory storing a first data set, the first data set having data collected from at least one sensor over a first time interval;
a second computer having the volatile memory storing a second data set having data collected from the at least one sensor over a second time interval after the first time interval; and,
a third computer configured to receive the first and second data sets from at least one of the first and second computers and to concurrently display at least a portion of the first and second data sets.

21. A facility monitoring system for obtaining data stored in a non-volatile memory and data stored in a volatile memory, comprising:
a first computer means operatively associated with the non-volatile memory for storing a first data set, the first data set having data collected from at least one sensor over a first time interval;
a second computer means having the volatile memory for storing a second data set having data collected from the at least one sensor over a second time interval after the first time interval; and,
a third computer means for receiving the first and second data sets from at least one of the first and second computers and storing at least a portion of the first and second data sets in a first memory.

22. An article of manufacture, comprising:
a computer storage medium having a computer program encoded therein for obtaining data stored in a nonvolatile memory and data stored in volatile memory in a facility monitoring system, the computer storage medium including:
code for retrieving a first data set stored in the nonvolatile memory associated with a first computer wherein the first data set includes data collected from at least one sensor over a first predetermined time interval;
code for retrieving a second data set stored in the volatile memory associated with a second computer wherein the second data set comprises data collected from the at least one sensor over a second time interval after the first time interval; and,
code for storing at least a portion of the first data set and the second data set in a first memory.

23. A facility monitoring system, comprising:
a computer including a non-volatile memory and a volatile memory, the computer configured to store a first data set in the non-volatile memory, the first data set having data collected from at least one sensor over a first time interval, the computer further configured to store in the volatile memory a second data set having data collected from the at least one sensor over a second time interval after the first time interval, the computer further configured to retrieve the first data set from the non-volatile memory and the second data set from the volatile memory and to store the first and second data sets in either the volatile memory or a first memory.
